(19) United States
(12) Patent Application Publication
(10) Pub. No.: US 2011/0029938 A1
(43) Pub. Date: Feb. 3, 2011

(54) PATTERN CREATING METHOD, COMPUTER PROGRAM PRODUCT, AND METHOD OF MANUFACTURING SEMICONDUCTOR DEVICE

(76) Inventors: Shigeki NOJIMA, Kanagawa (JP); Masahiro MIYAIRI, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/843,314

(22) Filed: Jul. 26, 2010

(30) Foreign Application Priority Data
Jul. 28, 2009 (JP) 2009-175700

(51) Int. Cl. G06F 17/50

(52) U.S. Cl. 716/53

(57) ABSTRACT

According to one embodiment, a pattern creating method includes: calculating, from pattern data on which a circuit pattern formed on a substrate and an auxiliary pattern not formed on the substrate are arranged, a first feature value of a first pattern edge of a circuit pattern affected by the auxiliary pattern and a second feature value of a second pattern edge connected to the first pattern edge; and arranging, when a relation between the feature values does not have a desired relation corresponding to the circuit pattern, the auxiliary pattern such that the relation between the feature values has the relation corresponding to a shape of the circuit pattern.

### CROSS-REFERENCE TO RELATED APPLICATIONS

This application is based upon and claims the benefit of priority from the prior Japanese Patent Application No. 2009-175700, filed on Jul. 28, 2009; the entire contents of which are incorporated herein by reference.

### FIELD

Embodiments described herein relate generally to a pattern creating method, a computer program product, and a method of manufacturing a semiconductor device.

### BACKGROUND

The advance of semiconductor manufacturing technologies in recent years is extremely remarkable. Semiconductor devices having the size in a minimum process dimension of 40 nanometers are mass-produced. Such microminiaturization of semiconductor devices is realized by the rapid progress of fine pattern forming technologies such as mask process technology, an optical lithography technology, and an etching technology. In the age when a pattern size was sufficiently large, a plane shape of an integrated circuit pattern formed on a wafer was directly drawn as a design pattern. A mask pattern faithful to the design pattern was created. A pattern substantially the same as the design pattern could be formed on the wafer by transferring the created mask pattern onto a wafer with a projection optical system and etching a base.

However, as microminiaturization of integrated circuit patterns advances, it is becoming difficult to faithfully form patterns in processes. As a result, a final finish dimension does not conform to a design pattern. In particular, in lithography and etching processes most important for attaining microprocessing, other patterns arranged around a pattern desired to be formed highly affect dimensional accuracy of the pattern desired to be formed. Technologies developed to prevent such influence are technologies called optical proximity correction (OPC) and process proximity correction (PPC). These are technologies for adding an auxiliary pattern in advance or increasing or decreasing the width of a pattern such that an integrated circuit pattern shape after processing conforms to a design pattern (a desired value) (see, for example, Japanese Patent Application Laid-Open No. H09-319067). The use of such OPC or PPC makes it possible to form a pattern drawn by a designer (design pattern data) on a wafer substantially as desired.

However, when fluctuation occurs in a manufacturing process, a pattern dimension and a pattern shape on the wafer cannot be fit in specifications only by the OPC or the PPC. Therefore, a technology for arranging a pattern having resolution equal to or lower than a resolution limit called sub resolution assist feature (SRAF) around a desired pattern is developed. As a method for the arrangement of the SRAF, for example, a method called rule base is adopted. In the rule base, the position of the SRAF is determined according to a distance between a pattern of attention and an adjacent pattern to arrange the SRAF. When the rule base is applied to design data of a rectangle such as a contact hole layer, the SRAF cannot always be arranged in an appropriate position in a contact hole arranged at random of a logic device or the like.

### BRIEF DESCRIPTION OF THE DRAWINGS

FIG. 1 is a block diagram of the configuration of a pattern correcting apparatus according to an embodiment of the present invention;

FIG. 2 is a flowchart for explaining a procedure of processing for creating mask data;

FIG. 3 is a flowchart for explaining in detail a procedure of processing for pattern correction;

FIG. 4 is a diagram for explaining an edge of attention and connected edges;

FIGS. 5A to 5G are diagrams for explaining processing for changing an SRAF;

FIG. 6 is a diagram of an example of contour data obtained when the SRAF is not changed;

FIG. 7 is a diagram of an example of contour data obtained when the SRAF changing processing in the embodiment is performed;

FIG. 8 is a flowchart for explaining in detail a procedure of processing for pattern correction performed to correct design pattern data before calculating a feature value;

FIG. 9 is a flowchart for explaining a procedure of processing for pattern correction performed when processing for calculating feature values and OPC processing are repeated a plurality of times; and

FIG. 10 is a diagram of the hardware configuration of the pattern correcting apparatus.

### DETAILED DESCRIPTION

In general, according to one embodiment, a pattern creating method includes calculating, from pattern data on which a circuit pattern formed on a substrate and an auxiliary pattern not formed on the substrate are arranged, a feature value of a first pattern edge of a circuit pattern affected by the auxiliary pattern as a first feature value; calculating a feature value of a second pattern edge connected to the first pattern edge as a second feature value; comparing the first feature value and the second feature value and determining whether a relation between the first feature value and the second feature value has a desired relation corresponding to the circuit pattern; and arranging, when the relation between the feature values does not have the relation corresponding to a shape of the circuit pattern, the auxiliary pattern such that the relation between the feature values has the relation corresponding to the shape of the circuit pattern.

Exemplary embodiments of a pattern creating method, a computer program product, and a method of manufacturing a semiconductor device will be explained below in detail with reference to the accompanying drawings. The present invention is not limited to the following embodiments.

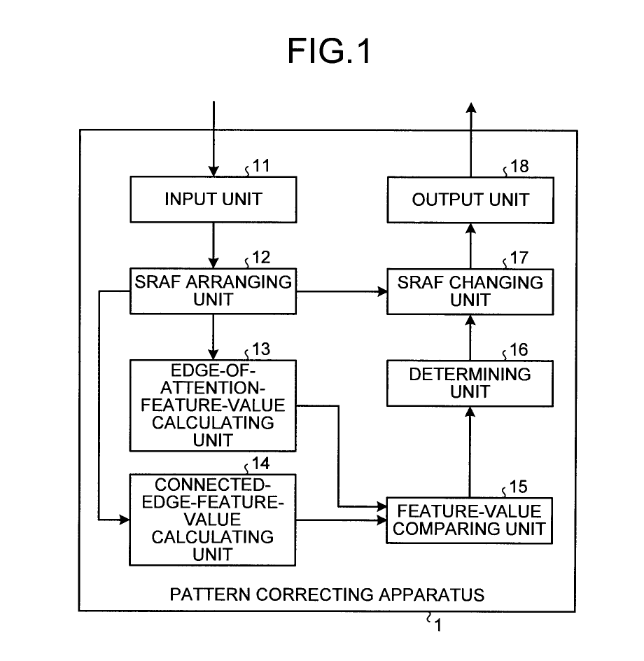

FIG. 1 is a block diagram of the configuration of a pattern correcting apparatus according to an embodiment of the present invention. A pattern correcting apparatus (a pattern creating apparatus) 1 is an apparatus such as a computer that arranges a sub resolution assist feature (SRAF) having resolution equal to or lower than a resolution limit in an appropriate position by simultaneously paying attention to a plurality of edges in design pattern data of a semiconductor device (an integrated circuit). The pattern correcting apparatus 1 changes, based on a feature value (a dimension, etc.) of a predetermined edge (an edge of attention Ea explained later) of a pattern affected by the SRAF in design pattern data and a feature value of predetermined edges (connected edges Eb explained later) connected to the edge of attention Ea, the SRAF as an auxiliary pattern such that a desired circuit pattern can be formed on a substrate such as a wafer. Specifically, for example, after arranging the SRAF on design pattern data used for hole processing in a semiconductor integrated circuit, the pattern correcting apparatus 1 adjusts (corrects) the position, the size, and the like of the SRAF such that pieces of feature value information (edge placement errors (EPE), normalized image log slopes (NILS), dimensions (CD), etc.) of the edge of attention Ea and the connected edges Eb have close values.

The SRAF can be arranged on a design pattern or can be arranged on a lithography target created by using the design pattern data. The pattern correcting apparatus 1 can change the SRAF arranged on the design pattern or can change the SRAF arranged on the lithography target. In the following explanation, the pattern correcting apparatus 1 changes the SRAF arranged on the design pattern data.

The pattern correcting apparatus 1 includes an input unit 11, an SRAF arranging unit 12, an edge-of-attention-feature-value calculating unit 13, a connected-edge-feature-value calculating unit 14, a feature-value comparing unit 15, a determining unit 16, an SRAF changing unit 17, and an output unit 18.

The input unit 11 receives the input of pattern data such as design pattern data (layout data) and a lithography target, various kinds of instruction information, and the like. The input unit 11 sends the input design pattern data to the SRAF arranging unit 12. The SRAF arranging unit 12 arranges the SRAF on the design pattern data.

The edge-of-attention-feature-value calculating unit 13 calculates (extracts), using the design pattern data, a feature value (an edge-of-attention feature value Ex explained later) of the edge of attention Ea affected by the SRAF. The connected-edge-feature-value calculating unit 14 calculates, using the design pattern data, a feature value (a connected-edge feature value Ey explained later) of the connected edges Eb connected to the edge of attention Ea (e.g., edges perpendicular to the edge of attention Ea). In the following explanation, in some case, the edge-of-attention feature value Ex and the connected-edge feature value Ey are referred to as feature values.

The edge-of-attention feature value Ex is, for example, a tilt of an optical image (light intensity distribution calculated by using simulation) of the edge of attention Ea, a dimension (a post lithography dimension of a pattern formed on the wafer) in a direction perpendicular to the edge of attention Ea, or a deviation amount between the position (a position on the design pattern or a position on the lithography target) of the edge of attention Ea and a simulation image. Similarly, the connected-edge feature value Ey is, for example, a tilt of an optical image (light intensity distribution calculated by using simulation) of the connected edges Eb, a post lithography dimension in a direction perpendicular to the connected edges Eb, or a deviation amount between the positions of the connected edges Eb and a simulation image.

The feature-value comparing unit 15 compares the edge-of-attention feature value Ex and the connected-edge feature value Ey. The determining unit 16 determines, based on a result of the comparison by the feature-value comparing unit 15 (a relation between the feature values), whether it is necessary to change the SRAF. When the determining unit 16 determines that it is necessary to change the SRAF, the SRAF changing unit 17 changes the SRAF such that a desired pattern can be formed on the wafer.

The output unit 18 outputs the design pattern data on which the SRAF is changed by the SRAF changing unit 17. When the SRAF is not changed by the SRAF changing unit 17, the output unit 18 directly outputs the design pattern data (the lithography target).

A procedure of processing for pattern correction performed by the pattern correcting apparatus 1 is explained below. In the past, as processing for creating mask data (pattern data formed on a photomask) using design pattern data (mask data preparation (MDP), mask data is created without performing a change of an SRAF. Specifically, in the past, SRAF arrangement, OPC, and the like are carried out based on the design pattern data to create data for a mask. In this embodiment, mask data on which an SRAF is changed such that a desired pattern can be formed on a wafer is created.

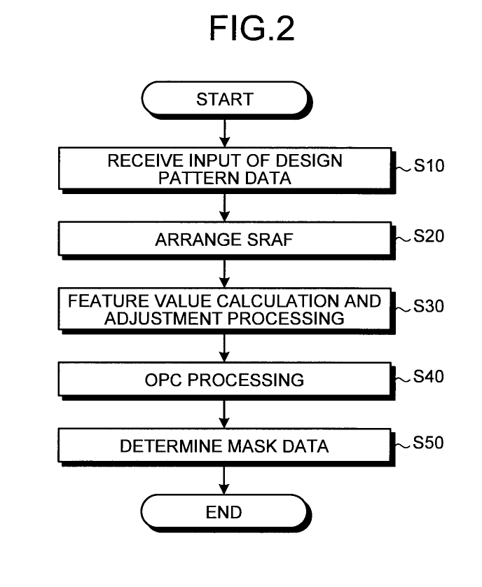

FIG. 2 is a flowchart for explaining a procedure of processing for creating mask data. Design pattern data is input to the input unit 11 (step S10). The input unit 11 sends the input design pattern data to the SRAF arranging unit 12. The SRAF arranging unit 12 arranges an SRAF on the design pattern data sent from the input unit 11 (step S20).

Thereafter, the edge-of-attention-feature-value calculating unit 13 calculates, using the design pattern data, a feature value of the edge of attention Ea affected by the SRAF as the edge-of-attention feature value Ex. The connected-edge-feature-value calculating unit 14 calculates, using the design pattern data, a feature value of the connected edges Eb connected to the edge of attention Ea as the connected-edge feature value Ey.

The feature-value comparing unit 15 compares the edge-of attention feature value Ex and the connected-edge feature value Ey. The determining unit 16 determines, based a result of the comparison by the feature-value comparing unit 15, whether it is necessary to change the SRAF. When the determining unit 16 determines that it is necessary to change the SRAF, the SRAF changing unit 17 changes the SRAF such that a desired pattern can be formed on the wafer. In this way, in this embodiment, for example, the calculation of the edge-of-attention feature value Ex and the connected-edge feature value Ey (feature-value calculation processing) and processing for changing the SRAF based on a result of the comparison of the feature values (adjustment processing) are performed (step S30).

The output unit 18 outputs the design pattern data on which the SRAF is changed by the SRAF changing unit 17. The design pattern data output from the output unit 18 is subjected to OPC processing by an OPC device or the like (step S40) and mask data is determined (step S50). A ratio of a longitudinal dimension and a lateral dimension (a dimensional ratio of the edge of attention Ea and the connected edges Eb) and the like of a pattern formed on a substrate are adjusted according to the change of the SRAF. The sizes of the pattern dimensions are adjusted by the OPC processing.

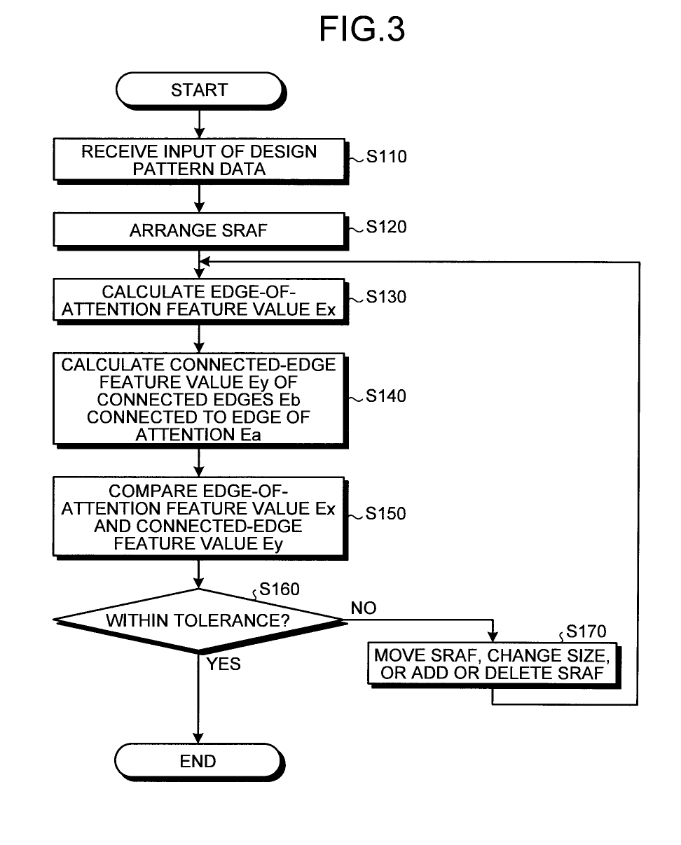

FIG. 3 is a flowchart for explaining the procedure of processing for pattern correction in detail. In FIG. 3, a procedure of processing for creating mask data (a pattern correction processing procedure) is shown. In the procedure of processing for creating mask data, the processing for calculating the edge-of-attention feature value Ex and the connected-edge feature value Ey, the SRAF adjustment processing, and the like are shown in detail.

Design pattern data is input to the input unit 11 (step S110). The input unit 11 sends the input design pattern data to the SRAF arranging unit 12. The SRAF arranging unit 12 arranges an SRAF on the design pattern data sent from the input unit 11 (step S120). The SRAF arranging unit 12 can arrange the SRAF using any method such as a method on a rule base or a method on a model base employing lithography simulation.

Thereafter, the edge-of-attention-feature-value calculating unit 13 calculates, using design pattern data, a feature value of the edge of attention Ea affected by the SRAF as the edge-of-attention feature value Ex (step S130). The connected-edge-feature-value calculating unit 14 calculates, using the design pattern data, a feature value of the connected edges Eb connected to the edge of attention Ea as the connected-edge feature value Ey (step S140).

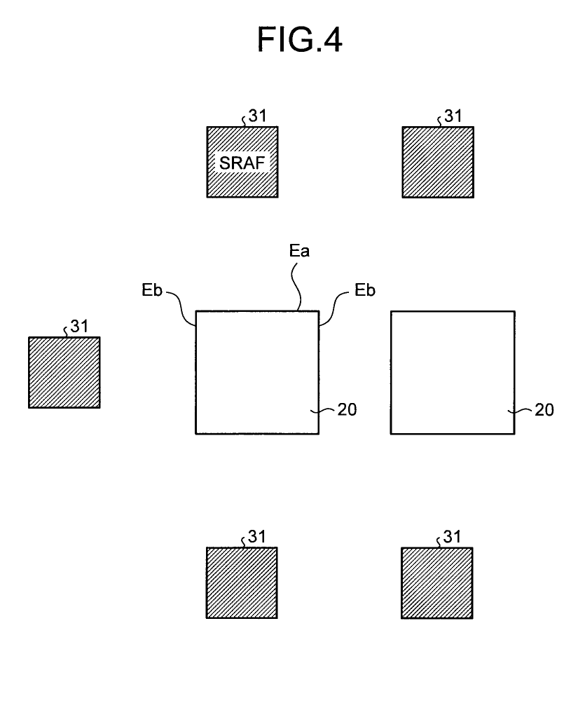

FIG. 4 is a diagram for explaining an edge of attention and connected edges. In FIG. 4, an example of a design pattern in a part of design pattern data, on which an SRAF is arranged, viewed from above is shown.

When an SRAF 31 is arranged with respect to a pattern (a design pattern 20) on design data of a pattern formed on a wafer, some pattern edge among pattern edges of the design pattern 2 is affected by the SRAF 31. In FIG. 4, a pattern edge affected by the SRAF 31 is the edge of attention Ea. The edge-of-attention-feature-value calculating unit 13 extracts the edge of attention Ea from the design pattern 20. The connected-edge-feature-value calculating unit 14 extracts the connected edges Eb connected to the edge of attention Ea from the design pattern 20. In FIG. 4, the design pattern 20 is a rectangle, the edge of attention Ea is an upper side extending in a lateral direction in the figure, and the connected edges Eb are sides extending in a longitudinal direction in the figure. When there are a plurality of the same connected edges Eb, the connected-edge-feature-value calculating unit 14 can extract only one connected edge Eb.

The edge-of-attention-feature-value calculating unit 13 calculates a feature value of the extracted edge of attention Ea as the edge-of-attention feature value Ex. The connected-edge-feature-value calculating unit 14 calculates a feature value of the extracted connected edges Eb as the connected-edge feature value Ey.

The edge-of-attention feature value Ex is, as explained above, for example, a tile of an optical image of the edge of attention Ea, a post lithography dimension in a direction perpendicular to the edge of attention Ea, or a deviation amount between the position of the edge of attention Ea and an simulation image. Similarly, the connected-edge feature value Ey is, for example, a tilt of an optical image of the connected edges Eb, a post lithography dimension in a direction perpendicular to the connected edges Eb, or a deviation amount between the positions of the connected edges Eb and a simulation image.

The post lithography dimension in the direction perpendicular to the edge of attention Ea is a post lithography dimension in the longitudinal direction of the design pattern 20. The post lithography dimension in the direction perpendicular to the connected edges Eb is a post lithography dimension in the lateral direction of the design pattern 20. The post lithography dimension in the direction perpendicular to the edge of attention Ea and the post lithography dimension in the direction perpendicular to the connected edges Eb are calculated by, for example, lithography simulation using the design pattern data on which the SRAF 31 is arranged.

Thereafter, the feature-value comparing unit 15 compares the edge-of-attention feature value Ex and the connected-edge feature value Ey. The feature-value comparing unit 15 calculates, for example, a difference between the edge-of-attention feature value Ex and the connected-edge feature value Ey (hereinafter, “feature value difference”). The feature-value comparing unit 15 can calculate a predetermined index value using the edge-of attention feature value Ex and the connected-edge feature value Ey (step S150).

The determining unit 16 determines, based on a result of the comparison by the feature-value comparing unit 15 and a value of the index value, whether it is necessary to change the SRAF 31. Specifically, the determining unit 16 determines whether a relation between the feature values has a relation corresponding to a shape of a circuit pattern formed on a substrate. In other words, the determining unit 16 determines whether the feature value difference or the index value is within a range of specifications determined in advance (within a tolerance) (step S160). The tolerance is a range indicating whether it is possible to form a desired pattern on a wafer. For example, when the shape of the circuit pattern is a circular shape, if the feature value difference is a difference of NILS, it is determined that a desired circular shape can be formed on the wafer when the difference between the edge-of-attention feature value Ex and the connected-edge feature value Ey is within a predetermined range. The determining unit 16 sends, to the SRAF changing unit 17, a result of the determination concerning whether it is necessary to change the SRAF 31.

When the feature value difference or the index value is not within the tolerance (“No” at step S160), the SRAF changing unit 17 changes the SRAF 31 such that the feature value difference or the index value fits in the tolerance. In other words, the SRAF changing unit 17 corrects the SRAF 31 such that the relation between the feature values has a relation corresponding to the shape of the circuit pattern formed on the substrate. The SRAF changing unit 17 changes the SRAF 31 such that, for example, the feature value difference decreases. Consequently, the SRAF changing unit 17 changes the SRAF 31 such that a desired pattern can be formed on the wafer. Specifically, the SRAF changing unit 17 performs, as processing for changing the SRAF 31, movement (position adjustment) or size change of the SRAF 31, addition or deletion of the SRAF 31, or the like (step S170).

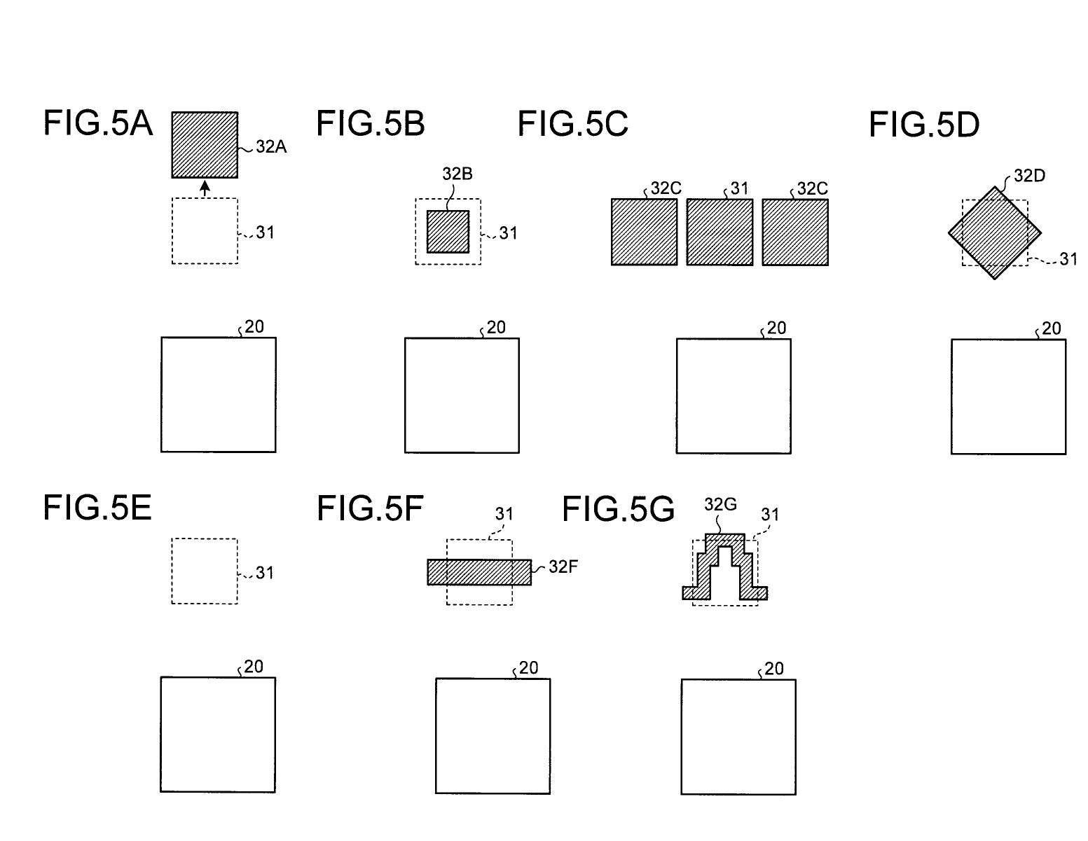

FIGS. 5A to 5G are diagrams for explaining processing for changing an SRAF. In FIG. 5A, processing for moving the SRAF 31 to the position of an SRAF 32A is shown. In FIG. 5B, processing for changing the size of the SRAF 31 to the size of an SRAF 32B is shown. Size adjustment for the SRAF 31 is not limited to a reduction in size of the SRAF 31. The size of the SRAF 31 can be increased.

In FIG. 5C, processing for adding SRAF 32C is shown. In FIG. 5D, processing for rotating the SRAF 31 in a pattern surface and moving the SRAF 31 to the position of an SRAF 32D is shown. In FIG. 5E, processing for deleting the SRAF 31 is shown.

In FIG. 5F, processing for changing the SRAF 31 to a rectangular SRAF 32F is shown. In FIG. 5G, processing for changing the SRAF 31 to an SRAF 32G having a step shape is shown. Processing for changing a pattern shape of the SRAF 31 is not limited to the processing for changing the SRAF 31 to the SRAF 32F and the SRAF 32G. The SRAF 31 can be changed to any shape.

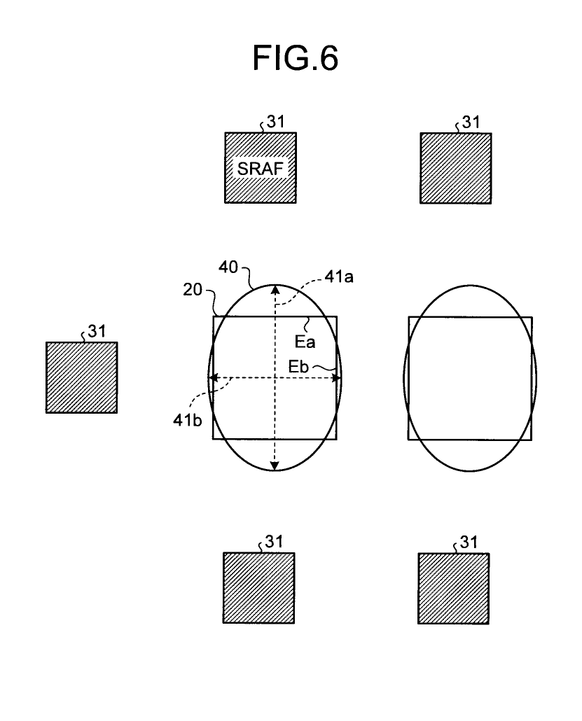

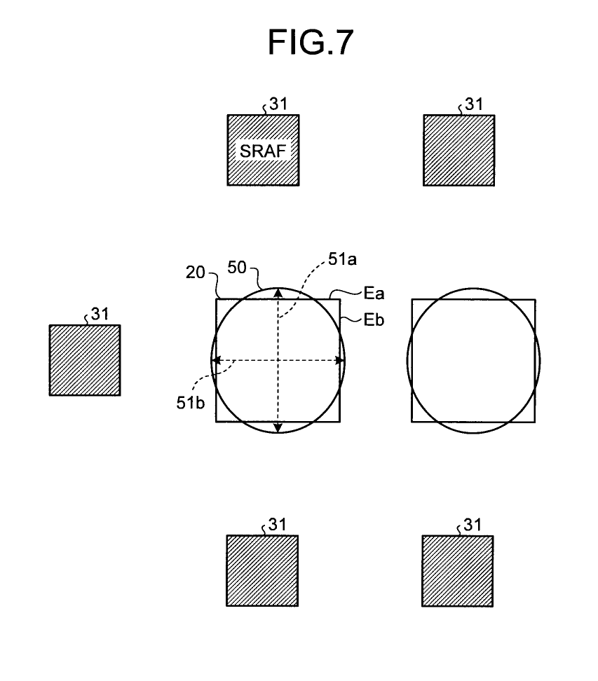

FIG. 6 is a diagram of an example of contour data obtained when an SRAF is not changed. FIG. 7 is a diagram of an example of contour data obtained when SRAF changing processing in this embodiment is performed. Contour data 40 and 50 shown in FIGS. 6 and 7 indicate contours (simulation results) of a post lithography pattern of the design pattern 20 shown in FIG. 4.

In the following explanation, the design pattern 20 (a lithography target) shown in FIG. 4 is an 85 nm square (a part of 40 nm logic device). A distortion ratio within 5% between a simulation CD (dimension) of the edge of attention Ea and a simulation CD of the connected edges Eb is defined as a tolerance.

An index value such as a distortion ratio can be indicated by, for example, Formula (1). The simulation CD (edge of attention CDs 41a and 51a) of the edge of attention Ea is represented as “SimCD” and a CD of a design pattern (a lateral side of the design pattern 20) of the edge of attention Ea is represented as “TCD”. A simulation CD (connected edge CDs 41b and 51b) of the connected edges Eb is represented as “ASimCD” and a CD of a design pattern (a longitudinal side of the design pattern 20) of the connected edges Eb is represented as “ATCD”.

Distortion ratio=|100−(SimCD/ASimCD)/(TCD/ATCD)| (1)

“TCD” and “ATCD” are the CDs of the design pattern. However, “TCD” and “ATCE” can be CDS of the lithography target. When the SRAF 31 was not changed, TCD and ATCD were 85 nanometers, SimCD was 96.7 nanometers, and ASimCD was 87.7 nanometers. A distortion ratio is calculated as 9.3% from Formula (1). In this way, when the SRAF 31 is not changed, for example, the contour data 40 has an elliptical shape shown in FIG. 6.

On the other hand, when the SRAF 31 was changed by the pattern correcting apparatus 1, SimCD was 93.2 nanometers and ASimCD was 90.9 nanometers. A distortion ratio is calculated as 2.5% from Formula (1). The distortion ratio is greatly improved compared with the distortion ratio obtained when the SRAF 31 is not changed. In this way, when the SRAF 31 is changed based on the edge-of-attention feature value Ex and the connected-edge feature value Ey, for example, the contour data 50 has a substantial circular shape shown in FIG. 7.

The design patterns of the edge of attention Ea and the connected edges Eb are used for calculation of the index value. However, the index value can be calculated by using lithography target dimensions of the edge of attention Ea and the connected edges Eb.

After the SRAF changing unit 17 changes the SRAF 31 such that the feature value difference or the index value fits in the tolerance, the pattern correcting apparatus 1 repeats the processing at steps S130 to S160 using design pattern data after the change of the SRAF 31. Specifically, the pattern correcting apparatus 1 extracts the edge-of-attention feature value Ex and the connected-edge feature value Ey using the design pattern data after the change of the SRAF 31. The pattern correcting apparatus 1 compares the edge-of-attention feature value Ex and the connected-edge feature value Ey. The pattern correcting apparatus 1 determines whether the feature value difference or the index value is within the tolerance. When the feature value difference or the index value is not within the tolerance (step S160), the pattern correcting apparatus 1 performs the processing for changing the SRAF 31. The pattern correcting apparatus 1 repeats the processing at steps S130 to S160 until the feature value difference or the index value fits in the tolerance. When the feature value difference or the index value fits in the tolerance, the pattern correcting apparatus 1 outputs, from the output unit 18, the design pattern data on which the SRAF 31 is changed. The design pattern data output from the output unit 18 is subjected to the OPC processing by the OPC device or the like.

When the OPC was carried out by using the pattern data before the improvement of the distortion ratio (the design pattern data on which the SRAF 31 is arranged), iterative calculation (OPC processing) needed to be performed seventeen times until a final simulation image fit in a range of ±1 nanometer of a desired lithography target (a design dimension). On the other hand, when the pattern correcting apparatus 1 carried out the OPC using the pattern data subjected to the pattern correction (on which the SRAF 31 was changed) (the pattern after the improvement of the distortion ratio), the iterative calculation only had to be performed ten times until the final simulation image fit in the range of ±1 nanometer of the desired lithography target. Time necessary for the OPC processing mainly depends on the iterative calculation. Therefore, it is possible to create mask data in a short time by changing the SRAF 31 and reducing the distortion ratio. It was found that, by changing the SRAF 31 and reducing the distortion ratio, when process fluctuation is taken into account, a dimensional variation amount decreased to 11.4 nanometers from 15.3 nanometers as an amount of dimensional variation that occurred when the SRAF 31 was not changed.

In this embodiment, the SRAF 31 is directly arranged on the design pattern data (the lithography target) to calculate the feature values (the edge-of-attention feature value Ex and the connected-edge feature value Ey). However, in some case, the feature values cannot be calculated even if the design pattern data is directly used. In this case, the feature values are calculated after correction processing for uniformly enlarging or reducing the design pattern data.

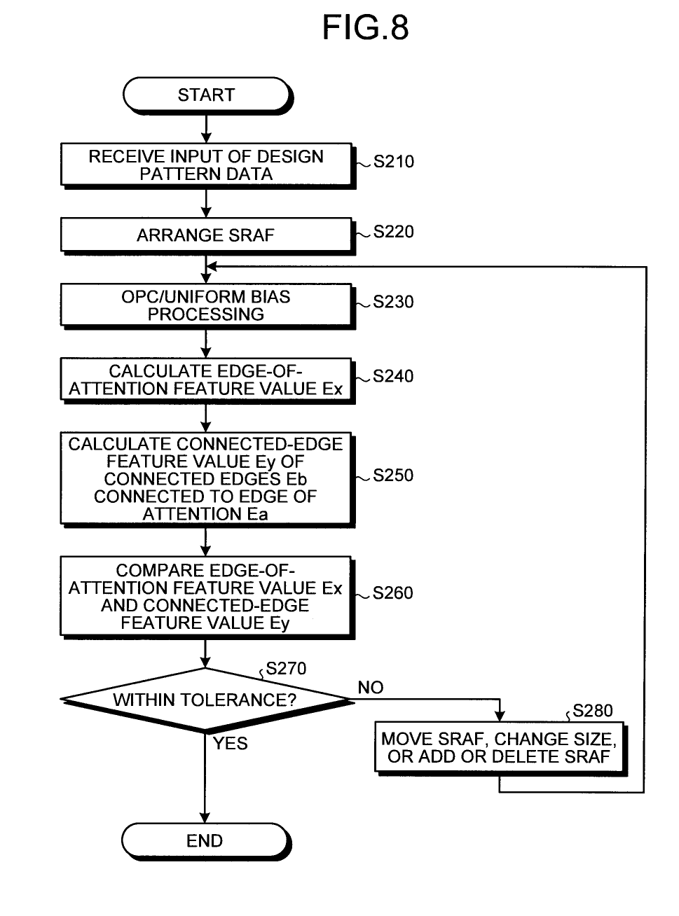

FIG. 8 is a flowchart for explaining in detail a procedure of processing for pattern correction performed when design pattern data is corrected before feature values are calculated. In the processing shown in FIG. 8, explanation of processing same as the processing explained with reference to FIG. 3 is omitted.

Design pattern data is input to the input unit 11 (step S210). The input unit 11 sends the input design pattern data to the SRAF arranging unit 12. The SRAF arranging unit 12 arranges the SRAF 31 on the design pattern data sent from the input unit 11 (step S220).

Thereafter, correction processing for uniformly enlarging or reducing the design pattern data (a lithography target) is performed. The processing for correcting the design pattern data can be performed by the SRAF arranging unit 12 of the pattern correcting apparatus 1 or can be performed by other devices (the OPC device, etc.). The processing for correcting the design pattern data is performed by repeating, for example, simple OPC several times. As the processing for correcting the design pattern data, bias processing can be uniformly applied to the design pattern data to uniformly enlarge or reduce the design pattern data (step S230). Thereafter, for example, the processing for calculating feature values explained with reference to FIG. 3 is performed (steps S240 to S280). The processing at steps S240 to S280 shown in FIG. 8 corresponds to the processing at steps S130 to S170 shown in FIG. 3.

In this embodiment, the OPC processing is performed after the edge-of-attention feature value Ex and the connected-edge feature value Ey are calculated once. However, the processing for calculating feature values and the OPC processing can be repeated two or more times.

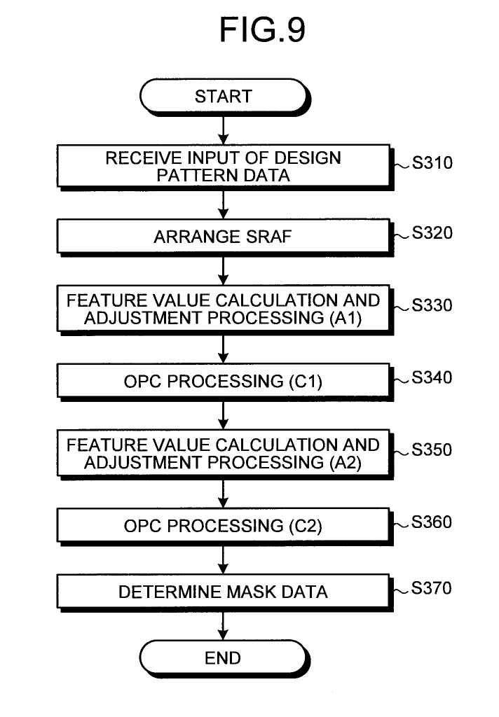

FIG. 9 is a flowchart of a procedure of processing for pattern correction performed when the processing for calculating feature values and the OPC processing are repeated a plurality of times. In the processing shown in FIG. 9, explanation of processing same as the processing explained with reference to FIG. 2 is omitted.

Design pattern data is input to the input unit 11 (step S310). The SRAF arranging unit 12 arranges the SRAF 31 on the design pattern data input to the input unit 11 (step S320).

Thereafter, first feature value calculation and adjustment processing (A1), for example, calculation of the edge-of-attention feature value Ex and the connected-edge feature value Ey and processing for adjusting the SRAF 31 based on a result of comparison of the feature values are performed (step S330). After the position and the like of the SRAF 31 are adjusted, first OPC processing (C1) is performed (step S340).

As second feature value calculation and adjustment processing (A2), for example, calculation of the edge-of-attention feature value Ex and the connected-edge feature value Ey and processing for adjusting the SRAF 31 based on a result of comparison of the feature values are performed (step S350). After the position and the like of the SRAF 31 are adjusted, second OPC processing (C2) is performed (step S360) and mask data is determined (step S370). In FIG. 9, the processing for calculating feature values and the OPC processing are repeated twice. However, the processing for calculating feature values and the OPC processing can be repeated three or more times.

After the pattern correcting apparatus 1 changes the SRAF 31 and the mask data is determined, a photomask is manufactured by using the mask data. A semiconductor device (a semiconductor integrated circuit) is manufactured by using the manufactured photomask in a wafer process. Specifically, an exposing device applies exposure processing to the wafer using the photomask on which the SRAF 31 is changed. Thereafter, development processing and etching processing for the wafer are performed. In other words, in a lithography process, a mask material is processed with a resist pattern formed by transfer and a processed film is patterned by etching using the patterned mask material. When the semiconductor device is manufactured, the processing for creating mask data (the processing for changing the SRAF 31), the exposure processing, the development processing, and the etching processing are repeated for each layer.

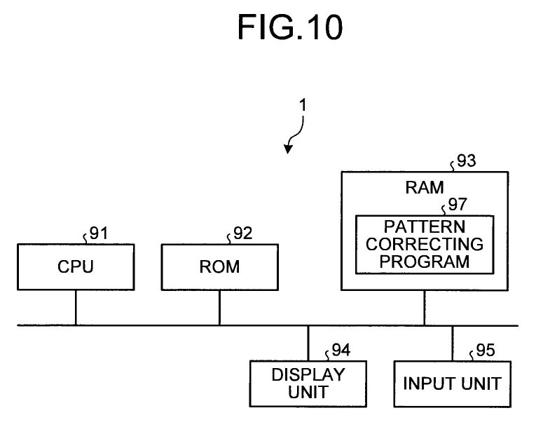

FIG. 10 is a diagram of the hardware configuration of the pattern correcting apparatus. The pattern correcting apparatus 1 is an apparatus such as a computer that changes the SRAF 31 arranged on design pattern data of a photomask used for exposure processing in a semiconductor device manufacturing step (pattern correction). The pattern correcting apparatus 1 includes a central processing unit (CPU) 91, a read only memory (ROM) 92, a random access memory (RAM) 93, a display unit 94, and an input unit 95. In the pattern correcting apparatus 1, the CPU 91, the ROM 92, the RAM 93, the display unit 94, and the input unit 95 are connected via a bus line.

The CPU 91 performs the pattern correction for the design pattern data using a pattern correcting program (a pattern creating program) 97 that is a computer program for performing correction of a pattern (a change of the SRAF 31). The display unit 94 is a display device such as a liquid crystal monitor. The display unit 94 displays, based on instructions from the CPU 91, design pattern data, a lithography target, the SRAF 31, and the like. The input unit 95 includes a mouse and a keyboard. The input unit 95 receives the input of instruction information (parameters and the like necessary for the pattern correction) externally input from a user. The instruction information input to the input unit 95 is sent to the CPU 91.

The pattern correcting program 97 is stored in the ROM 92 and loaded to the RAM 93 via a bus line. The CPU 91 executes the pattern correcting program 97 loaded in the RAM 93. Specifically, in the pattern correcting apparatus 1, the CPU 91 reads out the pattern correcting program 97 from the ROM 92, expands the pattern correcting program 97 in a program storage area in the RAM 93, and executes various kinds of processing according to the instruction input from the input unit 95 by the user. The CPU 91 temporarily stores, in a data storage area formed in the RAM 93, various data generated in the various kinds of processing.

In this embodiment, the pattern correcting apparatus 1 arranges the SRAF 31 on the design pattern data. However, the arrangement of the SRAF 31 can be performed by other apparatuses. In this case, the pattern correcting apparatus 1 does not have to include the SRAF arranging unit 12. The design pattern data on which the SRAF 31 is arranged is input to the input unit 11. The SRAF 31 is changed by using the design pattern data on which the SRAF 31 is arranged.

In this embodiment, the SRAF 31 is rectangular. However, the SRAF 31 can be formed in a shape other than the rectangle. It is also possible to calculate in advance, using various test patterns, appropriate position, shape, and the like of the SRAF 31 for each design pattern data and register the calculated position, shape, and the like of the SRAF 31 in a database. In this case, an appropriate change of the SRAF 31 corresponding to the design pattern data is performed by using the position, the shape, and the like of the SRAF 31 registered in the database.

As explained above, according to this embodiment, the SRAF 31 is adjusted such that the feature value difference between the edge-of-attention feature value Ex and the connected-edge feature value Ey fits in a range of specifications determined in advance. In this way, the SRAF 31 is changed such that a desired pattern can be formed on the wafer. This makes it possible to arrange the SRAF 31 in an appropriate position corresponding to a shape of the pattern formed on the wafer. Further, it is possible to reduce the OPC processing and turn around time (TAT) and expand a process margin.

The distortion ratio defined by Formula (1) or the like is set as the index value for determining whether the SRAF 31 is changed. This makes it possible to easily determine whether the SRAF 31 is changed.

The processing for correcting the SRAF 31 is at least one of the processing for changing the size of the SRAF 31, the processing for changing the position of the SRAF 31, the processing for changing the shape of the SRAF 31, the processing for adding the SRAF 31, and the processing for deleting the SRAF 31. This makes it possible to easily change the SRAF 31.

The design pattern data is corrected in advance by the OPC or the like before feature values are calculated. This makes it possible to calculate feature values directly using the design pattern data without depending on a pattern size of the design pattern data. The processing for calculating feature values and the OPC processing are repeated a plurality of times. This makes it possible to more appropriately correct the SRAF 31 than correcting the SRAF 31 by performing the processing for calculating feature values once.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A pattern creating method comprising:
calculating, from pattern data on which a circuit pattern formed on a substrate and an auxiliary pattern not formed on the substrate are arranged, a feature value of a first pattern edge of a circuit pattern affected by the auxiliary pattern as a first feature value;
calculating a feature value of a second pattern edge connected to the first pattern edge as a second feature value;
comparing the first feature value and the second feature value and determining whether a relation between the first feature value and the second feature value has a desired relation corresponding to the circuit pattern; and
arranging, when the relation between the feature values does not have the relation corresponding to a shape of the circuit pattern, the auxiliary pattern such that the relation between the feature values has the relation corresponding to the shape of the circuit pattern.

2. The pattern creating method according to claim 1, wherein
the first feature value and the second feature value are respectively a first pattern dimension as a pattern dimension in a direction perpendicular to the first pattern edge and a second pattern dimension as a pattern dimension in a direction perpendicular to the second pattern edge, and
the relation between the feature values is a distortion ratio of the circuit pattern defined by a ratio of the first pattern dimension and the second pattern dimension on the pattern data and a ratio of the first pattern dimension and the second pattern dimension as a simulation result calculated by simulation using the pattern data.

3. The pattern creating method according to claim 1, wherein processing for arranging the auxiliary pattern includes at least one of processing for changing a size of the auxiliary pattern, processing for changing a position of the auxiliary pattern, processing for changing a shape of the auxiliary pattern, processing for adding the auxiliary pattern, and processing for deleting the auxiliary pattern.

4. The pattern creating method according to claim 1, wherein
the first feature value and the second feature value are feature values of a same kind,
the first feature value is a tilt of an optical image of the first pattern edge, a dimension of the circuit pattern in a direction perpendicular to the first pattern edge, or a deviation amount between a position of the first pattern edge and a simulation image, and
the second feature value is a tile of an optical image of the second pattern edge, a dimension of the circuit pattern in a direction perpendicular to the second pattern edge, or a deviation amount between a position of the second pattern edge and a simulation image.

5. The pattern creating method according to claim 1, further comprising:
applying optical proximity correction to the pattern data, on which the auxiliary pattern is arranged, such that the relation between the feature values has the relation corresponding to the shape of the circuit pattern;
calculating a new first feature value and a new second feature value from the pattern data; and
re-executing the determination and the arrangement of the auxiliary pattern using the new first feature value and the new second feature value.

6. The pattern creating method according to claim 1, wherein the pattern data is data of design pattern on which the circuit pattern and the auxiliary pattern are arranged or lithography target data corresponding to the design pattern.

7. The pattern creating method according to claim 6, wherein the data of the design pattern or the lithography target data is data obtained after predetermined correction processing is performed.

8. A computer program product executable by a computer and having a computer-readable recording medium including a plurality of commands, the commands causing the computer to execute:
calculating, from pattern data on which a circuit pattern formed on a substrate and an auxiliary pattern not formed on the substrate are arranged, a feature value of a first pattern edge of a circuit pattern affected by the auxiliary pattern as a first feature value;
calculating a feature value of a second pattern edge connected to the first pattern edge as a second feature value;
comparing the first feature value and the second feature value and determining whether a relation between the first feature value and the second feature value has a desired relation corresponding to the circuit pattern; and
arranging, when the relation between the feature values does not have the relation corresponding to a shape of the circuit pattern, the auxiliary pattern such that the relation between the feature values has the relation corresponding to the shape of the circuit pattern.

9. The computer program product according to claim 8, wherein
the first feature value and the second feature value are respectively a first pattern dimension as a pattern dimension in a direction perpendicular to the first pattern edge and a second pattern dimension as a pattern dimension in a direction perpendicular to the second pattern edge, and
the relation between the feature values is a distortion ratio of the circuit pattern defined by a ratio of the first pattern dimension and the second pattern dimension on the pattern data and a ratio of the first pattern dimension and the second pattern dimension as a simulation result calculated by simulation using the pattern data.

10. The computer program product according to claim 8, wherein processing for arranging the auxiliary pattern includes at least one of processing for changing a size of the auxiliary pattern, processing for changing a position of the auxiliary pattern, processing for changing a shape of the auxiliary pattern, processing for adding the auxiliary pattern, and processing for deleting the auxiliary pattern.

11. The computer program product according to claim 8, wherein
the first feature value and the second feature value are feature values of a same kind,
the first feature value is a tilt of an optical image of the first pattern edge, a dimension of the circuit pattern in a direction perpendicular to the first pattern edge, or a deviation amount between a position of the first pattern edge and a simulation image, and
the second feature value is a tile of an optical image of the second pattern edge, a dimension of the circuit pattern in a direction perpendicular to the second pattern edge, or a deviation amount between a position of the second pattern edge and a simulation image.

12. The computer program product according to claim 8, wherein the commands cause the computer to further execute:
applying optical proximity correction to the pattern data, on which the auxiliary pattern is arranged, such that the relation between the feature values has the relation corresponding to the shape of the circuit pattern;
calculating a new first feature value and a new second feature value from the pattern data; and
re-executing the determination and the arrangement of the auxiliary pattern using the new first feature value and the new second feature value.

13. The computer program product according to claim 8, wherein the pattern data is data of design pattern on which the circuit pattern and the auxiliary pattern are arranged or lithography target data corresponding to the design pattern.

14. The computer program product according to claim 13, wherein the data of the design pattern or the lithography target data is data obtained after predetermined correction processing is performed.

15. A method of manufacturing a semiconductor device comprising:
calculating, from pattern data on which a circuit pattern formed on a substrate and an auxiliary pattern not formed on the substrate are arranged, a feature value of a first pattern edge of a circuit pattern affected by the auxiliary pattern as a first feature value;
calculating a feature value of a second pattern edge connected to the first pattern edge as a second feature value;
comparing the first feature value and the second feature value and determining whether a relation between the first feature value and the second feature value has a desired relation corresponding to the circuit pattern;
arranging, when the relation between the feature values does not have the relation corresponding to a shape of the circuit pattern, the auxiliary pattern such that the relation between the feature values has the relation corresponding to the shape of the circuit pattern;
manufacturing a photomask using the arranged auxiliary pattern; and
manufacturing a semiconductor device using the photomask.

16. The method of manufacturing a semiconductor device according to claim 15, wherein
the first feature value and the second feature value are respectively a first pattern dimension as a pattern dimension in a direction perpendicular to the first pattern edge and a second pattern dimension as a pattern dimension in a direction perpendicular to the second pattern edge, and
the relation between the feature values is a distortion ratio of the circuit pattern defined by a ratio of the first pattern dimension and the second pattern dimension on the pattern data and a ratio of the first pattern dimension and the second pattern dimension as a simulation result calculated by simulation using the pattern data.

17. The method of manufacturing a semiconductor device according to claim 15, wherein processing for arranging the auxiliary pattern includes at least one of processing for changing a size of the auxiliary pattern, processing for changing a position of the auxiliary pattern, processing for changing a shape of the auxiliary pattern, processing for adding the auxiliary pattern, and processing for deleting the auxiliary pattern.

18. The method of manufacturing a semiconductor device according to claim 15, wherein
the first feature value and the second feature value are feature values of a same kind,
the first feature value is a tilt of an optical image of the first pattern edge, a dimension of the circuit pattern in a direction perpendicular to the first pattern edge, or a deviation amount between a position of the first pattern edge and a simulation image, and
the second feature value is a tile of an optical image of the second pattern edge, a dimension of the circuit pattern in a direction perpendicular to the second pattern edge, or a deviation amount between a position of the second pattern edge and a simulation image.

19. The method of manufacturing a semiconductor device according to claim 15, further comprising:
applying optical proximity correction to the pattern data, on which the auxiliary pattern is arranged, such that the relation between the feature values has the relation corresponding to the shape of the circuit pattern;
calculating a new first feature value and a new second feature value from the pattern data; and
re-executing the determination and the arrangement of the auxiliary pattern using the new first feature value and the new second feature value.

20. The method of manufacturing a semiconductor device according to claim 15, wherein the pattern data is data of design pattern on which the circuit pattern and the auxiliary pattern are arranged or lithography target data corresponding to the design pattern.
